(19) United States
(12) Patent Application Publication
(10) Pub. No.: US 2003/0225623 A1
(43) Pub. Date: Dec. 4, 2003

(54) Method and system for conducting transactions using a payment card with account information encoded in bar code

(76) Inventor: John Wankmueller, Great Neck, NY (US)

Correspondence Address: BAKER & BOTTS, 30 ROCKEFELLER PLAZA, NEW YORK, NY, 10112

(21) Appl. No.: 10/336,336

(22) Filed: Jan. 3, 2003

Related U.S. Application Data
(60) Provisional application No. 60/346,206, filed on Jan. 4, 2002.

(51) Int. Cl. G06F 17/60

(52) U.S. Cl. 705/17; 705/41

(57) ABSTRACT

A system for conducting financial transactions is provided comprising: payment cards having stored account information in bar-coded format; and terminals each equipped with at least one optical bar code reader for reading the account information in bar-coded format, the terminals utilizing the account information for processing over a payment network and authorizing the financial transaction.

### PRIORITY APPLICATION

This application is based on U.S. provisional application 60/346,206 filed on Jan. 4, 2002, entitled “Method and System for Conducting Transactions Using a Payment Card With Account Information Encoded In Bar Code,” which is hereby incorporated by reference.

This application further claims priority to U.S. application Ser. No. 10/302,976, filed on Nov. 25, 2002, entitled “Method and System for Conducting Transactions Using a Payment Card With Two Technologies,” which is hereby incorporated by reference.

### BACKGROUND OF THE INVENTION

This invention relates to a method and system for conducting financial transactions using payment cards having account information stored therein in a bar code.

In today's marketplace, payment cards—such as credit, debit, and prepaid cards—are ubiquitous methods of payment. As used in this application, the term “payment card” includes not only payment cards in ISO 7810 ID-1 form factor, but also any other form factors that may hold payment account information, such as mobile phones, personal digital assistants (PDAs), and key fobs.

Most payment cards in use today use a magnetic stripe on the card to store payment account information for authorizing a transaction. Typically, to authorize a payment, the payment card is swiped through a card reader that reads the account information from the magnetic stripe on the card.

A drawback associated with the use of a magnetic stripe payment card is that it may be relatively time consuming and/or difficult to handle for certain applications. For example, when a consumer desires to pay for gasoline at the pump, the consumer typically wishes to conduct a fast transaction. The fact that a consumer must align the magnetic stripe on the payment card in the correct orientation for a card reader and swipe the payment card in a certain direction with a certain velocity means that a consumer must often fumble with the card to align it properly and may need to swipe the card more than once before the card reader is able to properly read it. In this situation, therefore, a conventional payment card may not be as fast and/or convenient a payment mechanism as a consumer might desire. The same also applies to purchases of fast food at fast food restaurants and convenience items at convenience stores.

To overcome the lack of speed and/or handling convenience of payment cards in the situations mentioned above, some companies have introduced other methods of payment. For example, the Exxon Mobil Oil Company has introduced the SPEEDPASS device. The SPEEDPASS device uses a radio frequency (RF) transmitter that transmits an identification code to an RF receiver installed either at the gas pump or at a payment register. To use the SPEEDPASS device, a user waves the device in close proximity to the RF receiver at the pump or register and waits for a light to indicate that the RF receiver has received and processed the identification code.

While convenient, the drawback with RF payment devices is the possibility of unauthorized reading of the identification information from these devices. That is, a person may utilize a concealed or camouflaged RF reader to steal the identification information from a user's RF payment device and use the stolen information to later conduct fraudulent transactions. To avoid unauthorized reading of the identification information, the information may be transmitted in encrypted form. Secure encryption, however, can be complicated and/or expensive, especially if a global deployment and global acceptance of payment cards is desired.

In addition, another drawback to the SPEEDPASS device is that it is only usable in a closed loop acceptance system (i.e., it is only usable at Mobil-supported terminals). It does not have the global acceptance of a payment card usable within a global payment network, such as the BANKNET network operated by MasterCard International Incorporated.

Therefore, there exists a need for a payment device and mechanism that is quick, easy, fast and secure and globally interoperable.

### SUMMARY OF THE INVENTION

According to the presently claimed invention, a system for conducting a financial transaction is provided, which includes payment cards having stored account information in bar-coded format. Terminals are equipped with at least one optical bar code reader for reading said account information in bar-coded format and for utilizing the account information for processing over a payment network and authorizing the financial transaction.

Preferably, the optical bar code reader formats the optically read account information into conventional track data for processing over said payment network.

Preferably, the optical bar code reader is omnidirectional so that the payment cards need not be aligned in any specific orientation with regard to the reader.

Advantageously, a system is provided which includes a payment device and mechanism which is quick, easy, fast and secure, and globally interoperable.

### BRIEF DESCRIPTION OF THE DRAWINGS

Exemplary embodiments of the present invention will now be described in detail with reference to the accompanying drawings in which:

FIG. 1 is a diagram of a payment card according to an exemplary embodiment of the present invention.

### DETAILED DESCRIPTION OF THE INVENTION

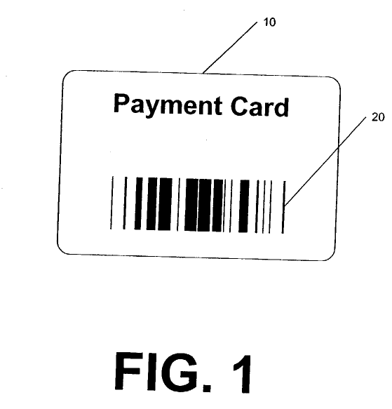

The present invention is directed to a payment device and method that provides a quick, easy, fast and secure way to pay for transactions. According to the presently claimed invention, a payment device includes payment account information that is stored in a bar code format. FIG. 1 is a diagram of a payment card according to a preferred embodiment of the present invention. As shown in FIG. 1, the present invention utilizes a payment card 10 with a bar code 20 thereon. The bar code may be graphically printed, imprinted or placed on the card in any manner known in the art. The bar code is encoded with the payment account information, including the BIN used to identify the issuer. A BIN (bank identification number) is a unique series of numbers that identifies the issuer of a card and which is used to route authorization request messages over existing payment card networks, such as the BANKNET network from MasterCard International Incorporated.

Preferably, the bar code includes the “Track 2” data typically found on the magnetic stripe of conventional payment cards. The Track 2 data is in BCD format and contains 40 BCD characters consisting of 1) a start sentinel (1 BCD character); 2) a PAN (of up to 19 BCD characters); 3) a field separator (1 BCD character); 4) an Expiry Date (4 BCD characters), 5) a Service Code (3 BCD characters); 6) discretionary data (the length of which is dependent on the length of the PAN); 7) end sentinel (1 BCD character); and 8) longitudinal redundancy check (LRC) (1 BCD character). The length of the discretionary data field is dependent on the length of the PAN. For a standard 16-digit payment account number, there are 13 digits available for the discretionary data. Of course, while Track 2 is preferred, other data tracks on the magnetic stripe may also be used with the present invention.

To use a payment card according to the present invention, a conventional point-of-sale (POS) or other payment terminal may be equipped with an optical bar code reader that reads the bar code on the payment card. The information read from the card is formatted in the reader (if necessary) into regular track data and processed in the same manner as a conventional payment card over existing payment networks. Preferably, the bar code reader used is an omnidirectional bar code reader so that the payment card/device of the present invention need not be aligned in any specific orientation with regard to the reader. Since payment account digits are communicated via the bar code, this payment card/device would not suffer from the same potential for theft of information as an RF-only payment device.

Although the present invention has been described with reference to certain preferred embodiments, various modifications, alterations, and substitutions will be known or obvious to those skilled in the art without departing from the spirit and scope of the invention. For example, while one bar code is shown in the preferred embodiment of FIG. 1, it is understood that multiple bar codes may be used with the present invention and that account information may be distributed over these multiple bar codes.

I claim:

1. A system for conducting financial transactions comprising:
payment cards having stored account information in bar-coded format; and
terminals equipped with at least one optical bar code reader for reading said account information in bar-coded format, said terminals utilizing said account information for processing over a payment network and obtaining authorization of said financial transaction.

2. The system of claim 1, wherein said optical bar code reader formats said optically read account information into conventional track data for said processing over said payment network.

3. The system of claim 2, wherein said optical bar code reader is omnidirectional so that said payment cards need not be aligned in any specific orientation with regard to the reader.

4. A method for conducting financial transactions comprising:
providing payment cards having stored account information in bar-coded format; and
providing terminals equipped with at least one optical bar code reader for reading said account information in bar-coded format, said terminals utilizing said account information for processing over a payment network and obtaining authorization of said financial transaction.

5. The method of claim 4, further comprising the step of formatting said optically read account information into conventional track data for said processing over said payment network.

6. The method of claim 5, wherein said optical bar code reader is omnidirectional so that said payment cards need not be aligned in any specific orientation with regard to the reader.
